(19) United States
(12) Patent Application Publication
(10) Pub. No.: US 2013/0046646 A1
(43) Pub. Date: Feb. 21, 2013

(54) Web Based Co-Op Trust Ownership Program

(71) Applicant: Derrick S. Malan, Maricopa, AZ (US)

(72) Inventor: Derrick S. Malan, Maricopa, AZ (US)

(21) Appl. No.: 13/588,682

(22) Filed: Aug. 17, 2012

Related U.S. Application Data
(60) Provisional application No. 61/525,119, filed on Aug. 18, 2011.

(51) Int. Cl. G06Q 30/06

(52) U.S. Cl. 705/26.2

(57) ABSTRACT

The present invention is a web-based fractional ownership system method to allow individuals to meet in the marketplace and conveniently find property for joint ownership. The web system provides a structure for individuals to discuss and jointly agree to own, operate, maintain, and sell items of mutual interest. The web based fractional ownership system organizes and promotes ownership of properties, and assists potential owners in finding other owners, of similar interests in both direct and indirect, efficient methods. The system also integrates prearranged service relationships for the joint members to apply for funding, acquire insurance, store the property, and perform routine maintenance.

### CROSS REFERENCE TO RELATED APPLICATIONS

This application claims the benefit of U.S. Provisional Application No. 61/525,119 filed on Aug. 18, 2011. The prior application is incorporated by reference herein.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING

Not applicable.

### BACKGROUND OF THE INVENTION

(1) Field of the Invention

This application is directed to establishment of a structure for a web based, multiple ownership system where individual owners meet to jointly share in ownership, legal structures, storage, maintenance, insurance, financing, communication, acquisitions, gifting, and selling of the following:
real estate properties,
rental opportunities,
vacations,
entertainment facilities,
recreational equipment,
other tangible assets such as, retail items, recreational equipment, personal property, business property, and salvage items; and
business opportunities.

(2) Description of Related Art

U.S. application Ser. No. 09/808,722 by Bennett et al describes an online purchasing system which includes a loan application system where joint ownership is mentioned as part of the application process. No mention is made with respect to a legal structure in regard to joint ownership, nor is there any mention of how individuals with similar interests who are seeking to share in ownership might meet in the marketplace. Also, U.S. application Ser. No. 09/953,452 by Linnenbringer et al, describes a method for generating electronic forms with similar limitations.

U.S. application Ser. No. 10/252,224 by Chatlain et al mention an insurance policy with joint ownership where input data is entered via a web based system, and the interests of the party are tracked online. However, the database is updated online and the parties of the insurance policy are already in agreement with respect to the policy prior to entering data. The web based system is primarily a data entry system for data fields for existing insurance policies and programs. There are no teachings with regard to methods or structures in place whereby multiple parties can meet to agree to share ownership in property or business opportunities.

U.S. Pat. No. 7,130,825 describes a joint ownership and auction system where items can be auctioned off as well as bought. An electronic ownership system is described, particularly in regard to commodity investments where transfers are initiated and executed, and the management of commodities is provided. This method is lacking in methods whereby potential owners of joint interest can meet to discuss and share ownership.

U.S. Pat. No. 7,212,982 describes a shared fractional aircraft ownership method. In particular, it describes a lease arrangement where individuals agree to have fractional ownership and additionally pay per flight. There is a discussion about a third party which will employ a flight crew to operate aircraft. It is directed toward a commercial venture. It does not meet the need of the marketplace where individuals can meet, discuss, and mutually acquire items of interest for hobby and recreational desires.

Expensive items purchased by individuals are often infrequently used. For example, fishing boats, speed boats, pleasure boats, etc. reside in a dock or storage and are un-used by the owner except for the occasion when the owner is available for a weekend or night when there is time for recreational activity. The actual amount of time the owner uses the boat, compared to the time it sits in the dock (or storage) is frequently very small. Joint ownership is an attractive option for such a person, as the costs are divided between users, and there is a reasonable likelihood that several people can use the boat without encumbering schedule conflicts.

However, it is readily apparent that there are issues among joint owners of a boat with obtaining insurance on a fractional ownership basis, obtaining a loan for a fractional cost of the total cost, scheduling, maintenance responsibility, fixing the boat if there is an accident, and the need for an agreement or legal framework to define these responsibilities. These are critical hindrances to the implementation of a joint ownership process, where several persons can meet together in a venue and have access to well thought out solutions in order to jointly buy, maintain, schedule, and ultimately dispose of a property when they agree they are ready to do something else with their money or time. Also, there is a need for a ready market where their partial ownership can be sold or disposed of so that they can use the money for other interests.

It is difficult to set up an efficient, joint ownership program due to the varying legal issues throughout the states. There are a number of changing and difficult legal requirements that are not efficiently dealt with by individual owners who desire joint ownership, and the state to state variance is intimidating and confusing for an individual or a small group of individuals who might attempt to coordinate through web communications, such as email. For example, some states may have a requirement that only three members can be listed as a joint owner. Various insurance agencies only work in particular states. And there are a variety of legal, financing, and insurance issues too numerous to mention. An online system must include a state by state component to allow legal flexibility to match current and local law. It must also be flexible to provide an updateable component to keep up with changing law practices.

In a broader sense, there exists a need in the market place where individuals can meet, court, and find each other to share ownership in other items of common interest, such as jet skis, vacation rental homes, condominiums, automobiles, trailers, recreational vehicles, boats, business investments, and other interests which make sense to own jointly. Individuals may want to only utilize a portion of the asset for a time, or minimize their exposure to liability, or reduce their responsibilities to maintain an item. For many, it is difficult to find other individuals of similar interests and meet in an environment conducive to engaging each other in a way that allows these kinds of transactions to proceed. Furthermore, it is time and cost prohibitive for any one individual to assemble the right components together from scratch. There exists a need to have all of these components easily accessible and prearranged to help individuals participate in the benefits of joint ownership.

### BRIEF SUMMARY OF THE INVENTION

The present invention is a web-based fractional ownership system method to allow individuals in geographically distinct areas throughout the United States to meet, court, and find like-minded people in the marketplace and conveniently find or suggest capital assets, properties, and items to organize into a structure where individuals will discuss and agree to jointly own, operate, maintain, and sell items of mutual interest. The web based fractional ownership system organizes and promotes ownership of properties, and assists potential owners in finding other owners, of similar interests in both direct and indirect, efficient manners. The invention further integrates prearranged service relationships for the members to apply for funding, acquire insurance, store the property, and perform routine maintenance.

### BRIEF DESCRIPTION OF THE SEVERAL VIEWS OF THE DRAWING(S)

FIG. 1 shows the initial interface between a user and the website.

FIG. 2 shows the next level between a user and the website

FIG. 3 shows important detailed aspects of links and social interactions between a user and the website.

FIG. 4 shows how users meet to fill a Div.

FIG. 5 shows communication between clients (users) and a server.

FIG. 6 shows communication between a website, a remote user, and a system administrator.

FIG. 7 shows a computer screen interface between a user and the user's personalized DivCity Website Dashboard.

### DETAILED DESCRIPTION OF THE INVENTION

Terms used in this application
Div: a web-based fractional ownership system covering a property that uses a Co-Op Trust to enable ownership with specific terms and conditions to govern the use of the property.
“Available” or “Potential” Div: A Div that is available to join.
“Filled” or “Full” Div: A Div where all membership slots have been filled, but not all steps have been taken to complete execution of ownership among members.
“Closed” or “Completed” Div: A Div where all members of the Div have completed all funding, insurance, tutorial, and other requirements spelled out in the terms and conditions. DivCity is then given responsibility to purchase and have product delivered according to the Div members' instructions.
Open Div: A Div that is open to the general public for joining
Private Div: A Div that is available to individuals by invitation only.
Independent Co-op Trust: A Div where a Co-Op Trust is used to enable fractional ownership with specific terms and conditions to govern the use of the property. In this case however, DivCity does not act as general manager.
DivCity Inventory: Property available to be selected for joint ownership in future Div.

The arrangement is that the asset/product of every Div will be owned by a trust. Div members are the trustees. So by identifying a property and asking members to join a Div, members are creating a Div through DivCity. When they sign off on the terms of use of the Div they will be signing a trust agreement. Div members are appointed as trustees, DivCity is appointed as general manager.

Div can be generically applied in a few different ways. On the website you can create a Div—i.e. create a co-op with terms and conditions that people can join and agree to (applies to potential Divs). On the Div dashboard you can view your Divs -- i.e. your filled and completed Divs. A Div will always have some type of asset connected to it. To join a Div each member must enter into a trust agreement that binds them to certain terms and conditions.

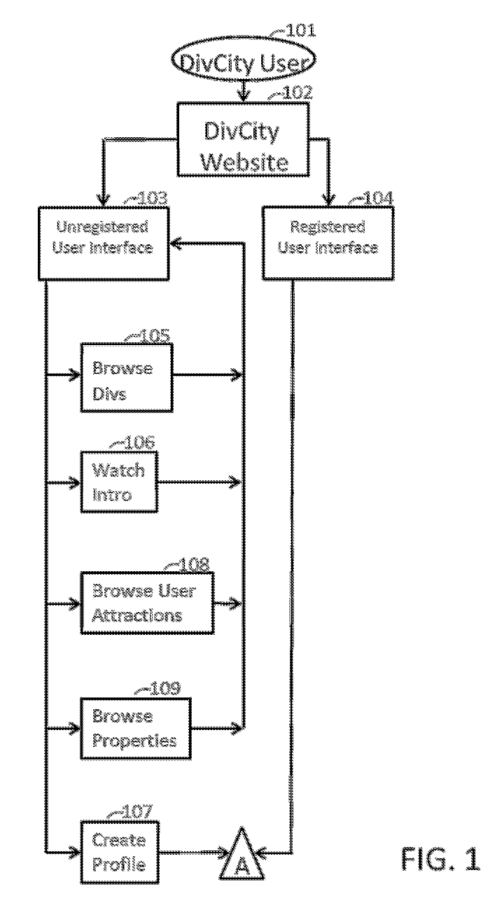

FIG. 1 shows how a user interfaces with the website called “DivCity.” A DivCity user 101 connects to the DivCity Website 102 which resides in a remote computer. On the home or initial webpage, the DivCity user, or simply user, has a choice to connect to other webpages by virtue of prior status. The status is whether or not the user is a registered DivCity user. The user may then proceed through clicking on commands to an un-registered user interface 103 or webpage, where the user can browse DivCity Inventory to fractionally own or the user can browse active Divs. Once a primary user begins a fractional ownership group, including selecting product, terms and conditions, the group is referred to as a “Div” 105 for potential ownership. The product post (or Div post) would include descriptions of potential properties, photos, MSRP, cost per Div member, number of Div positions filled, a link to terms and conditions related to the property, as well as any time sensitive information. The user would also be directed to an introduction 106 video or other audio/visual materials, where an introduction and description of the DivCity website along with a general description of various aspects of sharing ownership details are explained. This would include such items as scheduling, rules, regulations related to ownership, legal obligations, and requirements needed to keep membership status current. An unregistered user would also have the opportunity to register by creating a user profile 107, which would include all necessary information to allow proper legal contracts to be executed. The user can also browse properties (that are part of a Div or not part of a Div in DivCity inventory) 109 or review user attractions 108. Typical user attractions would be: Education Center, FAQ, Wall of Div Fame/Shame, Suggest a Div, Contest Info, etc.

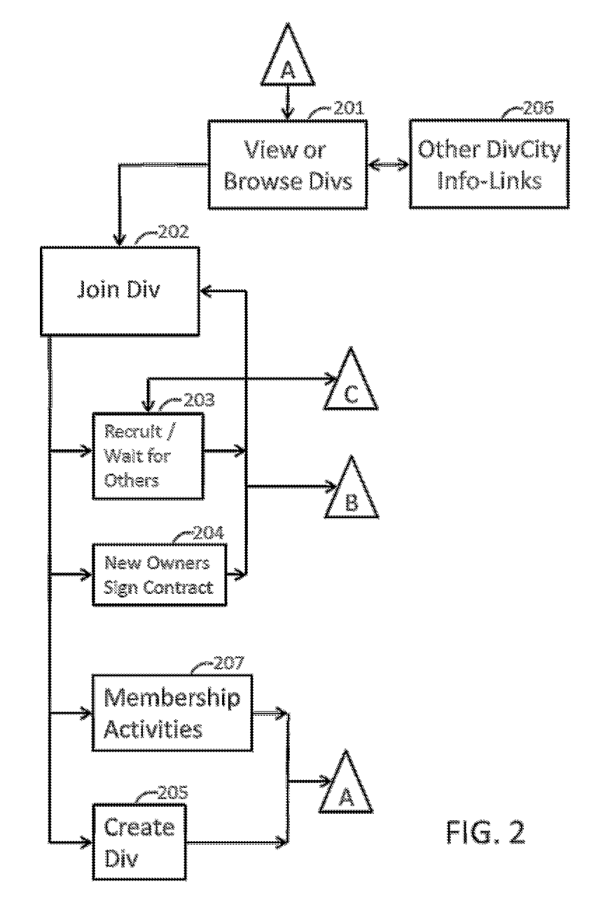

A registered user would be directed to the normal user interface/web pages 104 which would allow the user to contact other users and examine the Divs in more detail 201 or browse DivCity inventory as seen in FIG. 2. The registered user may view other DivCity information that may lie in other links, for example, manufacturer's data or an outside business that provides important services related to the property. The registered user can then Join a Div 202 and wait until the Div is completed based on the number of people required to complete a Div. The Div listing would include the necessary information needed before a Div can be completed. The number of people and amount of ownership percent that is required would be spelled out for the Div before any contract would actually be executed. If the DivCity user cannot find a Div they wish to join, the user may create a Div from DivCity inventory 205. A Div is created when the first user sets up and agrees to the terms and conditions. One parameter they choose is the number of Div members. Once all the slots are taken by Div members (they become a Div member by agreeing to the terms and conditions of the Div) the Div is full. Div members agree to the terms and conditions by signing a trust agreement 204, preferably electronically were allowable by law.

There are many possible membership activities 207 for Registered Users:
a) Participate in forums and group discussion
b) Go to “Div Dashboard”, where a User is able to track the progress of their Div(s), and has access to management tools, documents, etc.
c) Go to DivGiv, an area where gifting/fundraising for Divs is set up
d) Go to an area where there are incentives and attractions for Divs
e) Go to Div Match, an area similar to DivGiv where there are incentives to participate due to someone establishing a matching program.
f) Browse properties that are not part of a Div.

The registered user would also have a web based computer interface that gives insight into their pertinent user experience, e.g. Div Dashboard. They may view their current Divs, including outstanding items before the Div can be completed. They may view expired Divs. They may view a scheduling calendar for specific Divs. They may interact in a real-time forum with other members of their Div. As well as other tools to help facilitate completing, maintaining and utilizing their Div.

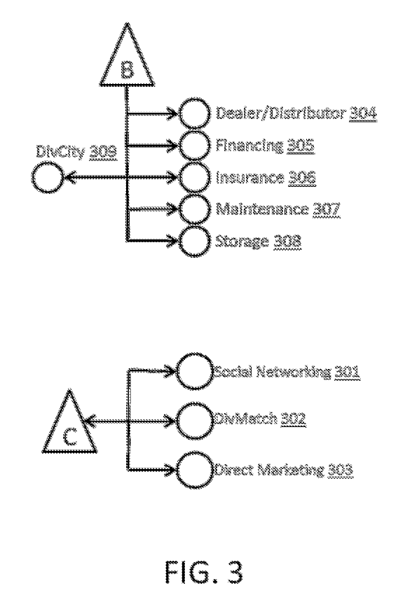

In FIG. 3, other places for the user to view/review with respect to a Div, are the Dealer/distributor of the property 304, the financing company and terms 305, the insurance company and terms 306, the maintenance contract where needed 307, and any storage requirements 308. Storage would be important for items such as boats and shared recreational equipment. The users can return to DivCity 309 website at any time. Particular Divs will be viewed by DivCity's network of professional service providers, i.e. the dealer/distributor of the property.

As an additional important benefit, DivCity's network of professional service providers, i.e. the dealer/distributor of the property, insurance provider, maintenance provider, storage provider, etc., will be connected to the DivCity website at the time of their choosing. The relationship between the user and the professional service providers will occur naturally as part of the DivCity experience. Many of these providers will be interacting with fractional owners for the very first time and this will create new ways to interact with customers. Forming and facilitating these relationships is intentional and part of the invention.

In one embodiment, the registered user will also have the option to be connected to the user's social networking websites 301. Thereby connecting the user's social network with the user's interests through the DivCity registration. The DivMatch system identifies individuals inside a social networking circle who are communicating about a particular Div, particular property or general property. These like-minded individuals in this circle are intelligently directed to each other to form a Div. There would also be a place where potential companies, or the website sponsor company, will be able to promote particular products and properties through direct marketing 303.

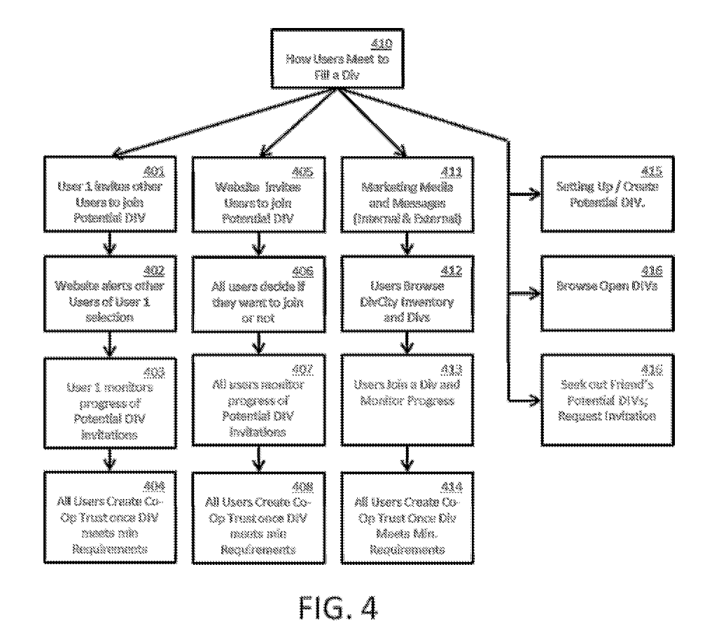

In FIG. 4, additional details are shown with respect to how Users 410 meet together to fill a Div. A User 1 may invite other users and non-users, herein “Persons” to join a Div 401, particularly when User 1 knows the other persons. The website then alerts 402 the other persons through email, instant messaging, or other communication such as voice or video conference, that User 1 has issued an invitation. User 1 then monitors the progress of Div invitations 403 through the website and may issue additional communication to invite the same or other persons to join the Div. Once all Div positions are filled and all Div members meet the minimum requirements, steps are taken to complete the Div 404. In another important embodiment, all users have access to the progress of Div invitations.

Another potential way for persons to meet together to fill a Div is when the website DivCity issues an invitation to Users to join a particular Div 405. This can be based on a wide variety of potential reasons, social links, known interests based on survey responses, email communications about Divs, and key word searching of Divs by the user. The users can then communicate and decide if they want to join the Div or not 406. The users may jointly monitor the progress of the Div invitations 407 and issue invitations to other persons. Once the Div requirements are met 408, the Div is filled.

Additionally, persons may meet together to fill a Div 410 through a marketing media and message 411 program or campaign (internal to DivCity or external). Marketing will include all media and messages that encourage persons to visit DivCity or browse a particular product or Div. This may include posted links from a user's social media site, from a search engine result, or from an affiliate's website; direct sales e.g. direct promotion from a company, a dealership, electronic or other publications, brokers, etc.; Div of the Day; a suggestion to a user from DivCity based on preferences; or an affiliate's verbal and personal invitation. Once persons come to the website, they will be able to browse products and Divs 412. This browsing may include searching by make, model, price, product type, Div name, Div ID, Div members including friends, almost filled Divs, Divs with members of a certain rating, etc. As stated in above paragraphs, users can Join a Div and monitor the progress of their Div 413 until users create a Co-Op Trust once the Div meet minimum requirements of the Div 414.

FIG. 4 illustrates three primary ways of how persons meet together to fill a Div.:
1. By invitation from another registered user.
2. Website invites a user(s) to join a potential Div.
3. Marketing.

Other ways a user can join a Div (additionally illustrated in FIG. 4) are:
1. By setting up, i.e. creating a potential Div 415.
2. By browsing open Divs, that are available to join 416
3. They may also choose to specifically seek out their friend's potential Divs, and request an invitation if needed or join if not 417.

Finding Divs. Users find Divs in a number of ways:
1. A user receives a direct invitation. An invitation may come from a friend who directly invites a user to join a potential Div with custom link.
2. A user sees a posted Div link, such as on another user's social networking site.
3. A user searches for Divs. When a user is on the DivCity website the user searches Divs. Possible search methods are by type, location, price, a friend's name, a company name, keyword, interests, suggested Divs, or most popular.
4. A user responds to an advertised Div. Possible advertisement methods include direct promotion from a company or by DivCity, Div of the Day, etc. via electronic correspondence, or advertisement in various media.

Typical steps to close a joint ownership:

1. Create/Join Div
a. Select asset from the DivCity inventory or join a Div
b. User is required to a create profile, and then sign into DivCity.
c. User electronically agrees to DivCity user agreement—terms and conditions
d. Verify Div selection
e. User agrees to all the terms of the Trust and Div (electronic acknowledgment with a simple check of a box—Trust Agreement, Exhibits, and additional acknowledgments—right of rescission period, funding and underwriting requirements, termination penalty, etc.)
f. At this point the Div has been created, the terms set and agreed to. But it is not ready to be executed. The Div Dashboard guides the user through the next steps.

2. Manage Div Completion via “Div Dashboard” (some tasks completed concurrently)
a. Fill all Div positions
   i. All positions must be filled by deadline, or Div shall:
      1. Reduce number of participants
      2. Be absorbed or consolidated with another similar Div
      3. Be terminated (default, if no other option is selected)
b. Users Complete Underwriting
   i. Insurance
      1. application paperwork will be available for download via the website
      2. paperwork will normally be in electronic, fillable form that can be saved to the user's computer.
      3. User will then upload these documents to DivCity through The Dashboard.
      4. insurance underwriting agent will have access to these documents for their review.
      5. Insurance underwriting agent will communicate any additional required pieces of information as well as the user's required monthly premium.
   ii. Financing
      1. will not apply to some users. Users will be able to pay by electronic check or credit card. For those who require financing, additional resources will be provided.
      2. Financing application will be available for download via the website.
      3. Application will normally be in electronic, fillable form that can be saved to the user's computer.
      4. User will then upload these documents and personal verification documents to a secure storage site through The Dashboard.
      5. Finance underwriting agent will have access to these documents for their review.
      6. Finance underwriting agent will communicate any additional required pieces of information as well as the user's loan qualification amount and terms of the loan.
c. Users Review Online Tutorials
d. Div members Provide Funding for the Div (i.e. Check, Credit Card, Financing)
   i. Funds go into a temporary holding account, similar to an escrow account.
e. Normally, the property/asset is now set aside by a dealership—asset identification number can now be used to specify the precise asset to be placed in the Co-Op Trust.
f. Users Fully Execute Co-Op Trust
   i. Electronic signature only after all Div positions have been filled, each member has been qualified, all required funds have been received.
   ii. Electronically sign any required service contracts, such as
      1. DivCity Management Agreement
      2. Storage
      3. Maintenance
      4. Insurance
      5. Financing

3. Execute Div Contracts
a. Once new Co-Op Trust is effective, and right of rescission periods have expired, General Manager (GM) signs purchase contract with the dealership. And then funds are exchanged for trustee positions with new trust entity as owner of the asset.
b. GM or appointee takes delivery at dealership
c. Asset is transported to a qualified storage facility
d. GM executes all service contracts

4. Div Member Enjoys Use of Asset of New Div
a. Member uses the DivCity Website to manage Div experience
   i. Calendaring, communication, promotions, document storage, quality control, etc.
   ii. DivCity coordinates delivery and payments of invoices for storage, maintenance, and financing if applicable.
b. GM provides on-going trust management, under the direction of the trustees, and as outlined in the Co-Op Trust documentation.

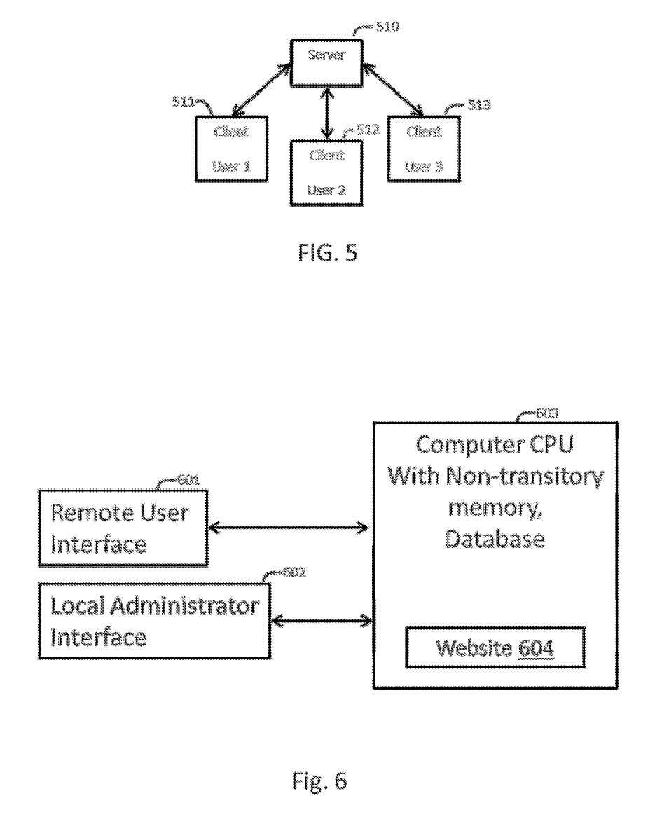

FIG. 5 shows a typical user interface where users 1 through user 3 (511-513) are connected remotely to a server 510 where the website resides. The users are not completely restricted to communication with each other through the DivCity website. They would have access to other communication services such as normal email accounts and instant messaging provided by others. Users may also communicate with the DivCity community of users as a whole by posting comments about particular products or about particular users. Users may be rated by other users based on personal experience inside other Divs. Users would also be accessing Div information through social websites.

FIG. 6 shows a typical computer central processing unit with memory, hard drive storage, along with programming and storage, and a database 603 for the Website DivCity. This would normally reside on a server, such as is typical for websites. There would be a remote user interface 601 and a local administrator interface 602.

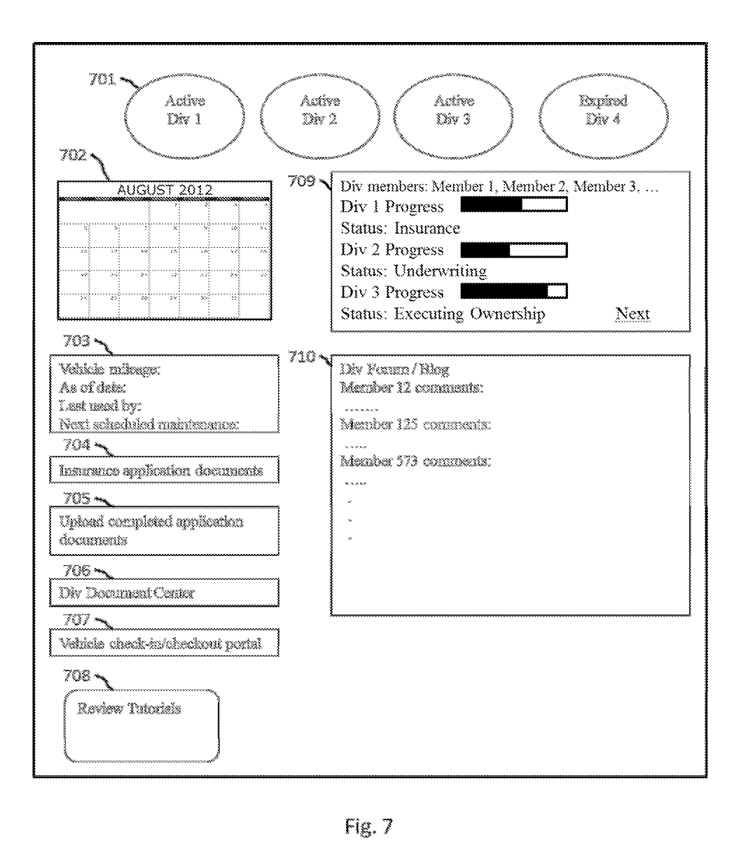

FIG. 7 illustrates a web based interface between the user and DivCity. A user may view active, inactive, and expired Div's 701, the user's personal Div schedule 702, information related to Div usage such as mileage, etc. when related to a vehicle 703, important information related to a Div such as insurance documents 704, an upload / download area 705 where the user can receive important documents for signature and review, a Div document center 706 where important Div documents can be previewed, a portal for checking in—out vehicles and property when a Div is shared among Div members 707, a special document area where tutorials and manuals are kept so a Div member can see how equipment / property items should operate 708, a Div status area 709 where the Div member can see current progress for Div's in progress, and a Div forum or Blog area 710 where Div members can discuss issues related to Divs and DivCity,

Another important embodiment of the present invention is to match potential joint owners together through mutual interests as defined by filled in surveys created by on line forms using a DivMatch function.

Another important embodiment is for individuals to provide a gift feature for existing or prospective DivCity members. Occasions such as birthdays, anniversaries, weddings, retirement, major life milestones, holidays, etc. where giving a gift would be a desirable gesture by an individual or a group of individuals, could be done by choosing a specific item to be gifted, a range of potential items to be chosen, or a monetary amount. The receiver of the gift would then become a part owner in a Div as in any other transaction, and be required to successfully complete any selection process related to that Div.

Those who participate in a “DivGive” (also be referred to as “DivGiv” or “DivGift”) may come through a variety of methods:
1) A person may create a Div specifically for the purpose of giving a gift. For example, they may want to purchase an item for their parent's anniversary. The Div they create, therefore, is open only to interested friends and family members—most likely by invitation only. The parents in this case are wholly the recipients of the DivGive. In addition, the recipients of a DivGive do not need to be affiliated with DivCity in any way. The DivGive stipulations may request shipment to/pickup from a particular party once the DivGive has been fully funded, and the DivCity website will comply, regardless of DivCity affiliation.
2) Ownership in an existing Div may be gifted to another, as long as the guidelines for the existing Div allow for it (i.e. open to general public, qualifications, etc.). In this case the recipient of the gifted portion of existing Div may (or may not) need to be an existing DivCity member.
3) DivGives may also come as suggestions from the DivCity Website to those who are members of DivCity. For example: the DivCity Website may note that a listed friend of a DivCity member is having a birthday in a few days and a friend is a current member of DivCity. DivCity can send a suggestion/invitation to the DivCity member to participate in a DivGive for the benefit of their friend. The item being gifted through the DivGive does not need to be large. It might be an electronic item such as a cell phone or a gaming system. If they elect to participate in a DivGive, they can choose to donate a certain amount toward the cause (say $5.00), and then invite other friends to do the same. DivCity then forwards the DivGive invitations to appropriate DivCity members and the receiving members will forward the same invitations to their friends outside the DivCity network. Once the DivGive is funded, the recipient will be notified with attached notes / comments / congratulations offered by all those who participated in the DivGive.

Another important embodiment of the present invention is to match potential joint owners together through other means, such as social websites through mutual friend lists, and friends with similar interests. The similar interests may be determined potentially by programs which will survey/track:
a) Words in messages between DivCity members between each other or other persons, including any of:
   i. email
   ii. instant messaging
   iii. website postings
   iv. Blogs
   v. Phone text messages
b) Chat room postings and discussions
c) Website browsing habits
d) Frequency of communication and words used
e) Response to any online advertising
f) Length of time and number of times a site is visited
g) People on social website not visited to define what interests are not high priority
h) Online survey forms filled in about interests / hobbies

Joint ownership matches are possible by methods utilizing programming and statistical algorithms, including mathematical algorithms, word compilation databases, and keyword tracking related to potential items available for joint ownership. Once a potential interest is identified, it is then presented to a DivCity member for consideration of joint ownership.

Internally this is called the DivMatch system. Suggested matches may come a number of ways. Here are examples:
1. a user logs onto DivCity using their Facebook username and password. DivCity then:
   a. intelligently directs—suggests to this user: other users in their social network who are logged onto DivCity, or
   b. intelligently directs—suggests to this user: persons in their social network who are posting about similar products of interest on the person's networking site.
2. before a new Div is created with the same DivCity inventory, user is asked to join a current Div instead of creating a new one.

The tracking methods will be governed by a ruling authority such as policies of DivCity, as allowed by law, software licensing agreements, or as permitted by DivCity members through online permission protocols.

Another embodiment envisioned in the present invention is a reward-penalty system for joint owners. When an owner has fractional ownership, there is less incentive to maintain equipment in complete working order, and to remember needed maintenance. Also, situations potentially arise, which may cause a fractional owner to cause inconvenience to other owners who use the property such as:
a) damage by misuse of a property, whether intentional or unintentional,
b) improper use other than its designed use causing shorter life or higher maintenance,
c) scheduling issues, such as using or committing a property beyond agreed upon scheduling times and dates, or impulsively using a property beyond agreements, or
d) improper disposal of a property unauthorized by DivCity, such as a sale.

These types of issues are addressed by an online personal DivCity partner rating system, or alternately, a reward / penalty system. In one example, a DivCity member is rated by other DivCity partners for use of a property and adherence to schedule.

Another method conceived in the present invention is a reward to a DivCity member by allowing access to other similar properties based on mutual agreements between DivCity partners who jointly wish to expand their potential opportunity to use property. A penalty may be imposed upon a DivCity partner with a bad rating to give that owner a lower priority in scheduling or allow less desirable access to the property for a defined period of time. For example, a prospective DivCity partner can be barred from joining a particular Div that is being created by the currently accepted partners already allowed into the particular Div. (The DivCity partner's rating is will be viewable during the invitation process). This will provide an important incentive to all DivCity partners to maintain a high rating. Current Div members can refuse another DivCity member based on a defined criterion/majority rule.

Invitations to a Div can sometimes be very personal to a particular group, and may require certain criterion such as geographic restriction, or a specific scheduling criterion to join the group.

The actual scheduling is not be determined before the Div is fully created, only the method of determining the scheduling is agreed upon. For example, the original creator of the Div may choose the “Draft” method, which is roughly comparable to the current draft system such as found in professional sports. Typically, the Div members may choose from a number of methods presented to them at the point of Div creation, but none will offer any unfair advantage of one Div member over another potential Div member who will join the Div later on.

It is expected that invitations to a Div may be very personal, and the original Div creator may create specific criterion that must be met before joining a Div. For example, the Div creator may choose to open a Div to be by invitation only, or those who are already part of a particular friend circle, or perhaps only to those who have high community user ratings. Once the Div is created, the current Div members have a specific period of time in order to have the Div fully formed (have all members of Div identified), or the Div will either be dissolved, or will become open to others to join, depending on how the Div group has formed the Div.

A final embodiment includes the method for product check-in and check-out procedures from a storage facility. The DivCity website will facilitate an electronic method for the same. Div members can logon to their Div Dashboard via a device capable of connecting to the Internet at the time of Check-In or Checkout which includes a mobile device capable of connecting to the internet and is able to use DivCity's website. Div members will fill out certain fields which may include mileage, condition, time, etc. Div members will be able to upload photos of the product especially if there is damage to their vehicle. Div Dashboard will be viewable by other members of the Div. This embodiment additionally includes the use of a mobile phone, via a mobile application, i.e. mobile app, to facilitate this procedure as well as other procedures and tasks mentioned in this document.

While various embodiments of the present invention have been described, the invention may be modified and adapted to various operational methods to those skilled in the art. Therefore, this invention is not limited to the description and figure shown herein, and includes all such embodiments, changes, and modifications that are encompassed by the scope of the claims.

What is claimed is:

1. A method comprising:
a) a computer based system comprising a processor and a tangible and non-transitory memory,
/b) a computer-readable medium encoded with a computer program loaded into said computer based system for the purpose of creating a website on the world wide web,
c) identifying a property for fractional ownership,
d) identifying individuals to become fractional owners according to a predetermined criterion,
e) using said website for:
i) communicating steps to said individuals for obtaining joint ownership of said property as a trust,
ii) facilitating said individuals to engage in a substantive and defined joint ownership agreement to achieve said joint ownership of said property,
iii) providing for said fractional owners to complete at least some obligations of joint ownership, and
iv) facilitating said individuals and said fractional owners to find, meet, and communicate with each other,
f) wherein said steps include executing legal procedures to obtain said joint ownership of said property.

2. The method for joint ownership of property according to claim 1 wherein any said fractional owner has proportional rights to said property based substantially on an amount paid for said property.

3. The method for joint ownership of property according to claim 1 wherein any said property is a tangible property or an intangible property, wherein said tangible property comprises at least one item selected from the group consisting of:
a) recreational equipment,
b) real estate,
c) personal property,
d) business property, and
e) salvage items,
wherein said intangible property comprises at least one item selected from the group consisting of:
a) estates,
b) trusts,
c) intellectual property,
d) businesses,
e) investment instruments, and
f) mineral rights.

4. The method for joint ownership of property according to claim 1 wherein any said fractional owner identifies said property for sale and lists said property on said website for potential said joint ownership.

5. The method for joint ownership of property according to claim 1 wherein said fractional owners of said property contractually agree with a third party to provide scheduling, maintenance, insurance, funding, storage and property management services.

6. The method for joint ownership of property according to claim 1 wherein a computer-readable medium encoded with a second computer program incorporates the predetermined criterion, wherein said predetermined criterion incorporates at least one item from the group consisting of:
a) words in messages between said individuals,
b) chat room postings and chat room discussions by said individuals,
c) website browsing habits of said individuals,
d) frequency of communication and words used by said individuals while online,
e) response to any online advertising by said individuals,
f) length of time a website is visited by said individuals,
g) number of times a website is visited by said individuals, and
h) online survey forms filled in by said individuals related to interests and hobbies.

7. The method for joint ownership of property according to claim 1 wherein professional service providers have been prearranged to perform the following tasks on said property:
a) maintenance,
b) scheduling said property's availability, and
c) executing legal documents:
i) insurance underwriting and approval, and
ii) loan underwriting and approval
d) payment of taxes, registration, and insurance, on behalf of said defined joint ownership agreement.

8. The method for joint ownership of property according to claim 1 wherein the method of suggesting a property for joint ownership by use of a computer-readable medium encoded with a computer program incorporates at least one item from the group consisting of:
a) words in communications between said individuals,
b) chat room postings and chat room discussions by said individuals,
c) website browsing habits of said individuals,
d) frequency of communication and words used by said individuals while online,
e) response to any online advertising by said individuals,
f) length of time a website is visited by said individuals,
g) number of times a website is visited by said individuals, and
h) online survey forms filled in by said individuals related to interests and hobbies.

9. The method for joint ownership of property according to claim 1 wherein said property comprises a plurality of assets, wherein said assets are of a similar or different type.

10. The method according to claim 1 wherein said predetermined criterion is by invitation only.

11. The method according to claim 1 wherein said trust is an independent co-op trust and said fractional joint owners are trustees.

12. The method according to claim 1 wherein said website is owned by an administering company.

13. The method according to claim 1 wherein an inventory of available properties is listed on said website, and said individuals browse said inventory.

14. The method according to claim 1 wherein a registered individual provisionally agrees to a joint ownership agreement under a predetermined criterion, wherein said predetermined criterion includes the number of registered individuals required to complete said joint ownership agreement.

15. The method according to claim 1 wherein said individual logs onto said website to engage in one the activities selected from the group consisting of:
i. participate in forums and group discussions,
ii. monitor fractional ownership agreements without regard to status,
iii. monitor giving agreements,
iv. view and participate in incentives related to joint ownership agreements,
v. view and participate in giving incentives, and
vi. browse any properties that are not subject to an associated joint ownership agreement,
and wherein said individual views any one of the following items selected from the group consisting of:
i. a dealer/distributor associated with said property,
ii. any associated financing company and terms,
iii. any insurance company and terms,
iv. any maintenance contract, and
v. any storage requirements.

16. The method according to claim 1 wherein said predetermined criterion includes at least one social website, wherein said at least one social website primarily communicates through the use of:
a) email,
b) instant messaging,
c) website postings,
d) blogs,
e) phone text messages, and
f) chat room postings and discussions,
and said predetermined criterion includes the use of at least one item from the group consisting of:
a) website browsing habits,
b) frequency of communication and words used,
c) response to any online advertising,
d) length of time and number of times a site is visited,
e) people on social website not visited to define what interests are not high priority, and
f) online survey forms filled in about interests and hobbies.

17. The method according to claim 1 wherein said predetermined criterion includes marketing by a third party including:
a) media and messages about a particular property,
b) posted links from said social website,
c) link or advertisement from a search engine result,
d) link or advertisement from an affiliate's website,
e) direct promotion by electronic communication,
f) special said website posting,
g) a suggestion on said website to said individual based on preferences, or
h) a verbal or personal invitation.

18. The method according to claim 1 wherein said predetermined criterion includes:
a) invitation from another registered individual,
b) an administration company which owns said website suggests multiple said individuals,
c) marketing,
d) setting up said steps associated with an available property,
e) browsing any available joint ownership agreement, and
f) search for a particular joint ownership agreement.

19. The method according to claim 1 wherein said joint ownership agreement incorporates a gift feature.

20. The method according to claim 1 wherein said individuals become registered users at said website, and said registered users rate each other according to a predetermined criterion and submit said rating information to said website.
